(19) United States
(12) Patent Application Publication
(10) Pub. No.: US 2017/0317948 A1
(43) Pub. Date: Nov. 2, 2017

(54) HOSTING APPS WITH NATIVE CAPABILITIES

(71) Applicant: Microsoft Technology Licensing, LLC, Redmond, WA (US)

(72) Inventors: Faisal Khaled Faisal Ilaiwi, Bellevue, WA (US); Bryan Thomas Phelps, Bellevue, WA (US); Yasser Elsayed, Bothell, WA (US); Christoph Ponath, Bothell, WA (US)

(21) Appl. No.: 15/199,654

(22) Filed: Jun. 30, 2016

Related U.S. Application Data
(60) Provisional application No. 62/329,106, filed on Apr. 28, 2016.

(51) Int. Cl. H04L 12/927; H04L 29/08

(52) U.S. Cl. CPC H04L 47/803; H04L 67/02; H04L 67/16

(57) ABSTRACT

Hosting one or more web applications and providing local device capabilities to the one or more web applications. One or more second applications are hosted within a first application. A call from the one or more second applications is performed to a device abstraction layer of the first application. Such a performed call comprises a request to access a capability of a local device. Upon receiving the call, the device abstraction layer verifies that the performed call is permitted. In response to the first application verifying that the performed call is permitted, the one or more second applications is permitted to access the capability of the local device that was requested.

### CROSS-REFERENCE TO RELATED APPLICATION

This application claims the benefit of U.S. Provisional Patent Application Ser. No. 62/329,106 filed Apr. 28, 2016, which provisional patent application is incorporated herein by reference in its entirety.

### BACKGROUND

Computer systems and related technology affect many aspects of society. Indeed, the computer system's ability to process information has transformed the way we live and work. Software programs, or applications, enable computer systems to obtain a high degree of functionality. Through the use of mobile computers, phones, and tablets, software applications have become an integral part of the way many individuals live and work. More recently, software applications have been hosted in cloud environments that allow the software applications to be utilized from various devices and computer environments.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to hosting one or more web applications and providing local device capabilities to the one or more web applications. For example, embodiments may include hosting one or more second applications within a first application. A call from the one or more second applications may be performed to a device abstraction layer of the first application. Such a performed call may comprise a request to access a capability of a local device. Upon receiving the call, the device abstraction layer may verify that the performed call is permitted. In response to the first application verifying that the performed call is permitted, the one or more second applications may be permitted to access the capability of the local device that was requested.

Accordingly, an app host utilizing a device abstraction layer may provide hosted applications with access to cross-platform functionality and local device capabilities, while also sandboxing hosted applications to ensure safety of local devices. Furthermore, the app host may allow for opening/closing hosted apps, allowing multiple apps to be open at any given time, defining hosted app capabilities, modifying hosted apps, building UI around and on top of hosted apps on all major mobile platforms at once, and easily updating an infrastructure of the app host.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may be employed.

FIG. 2 symbolically illustrates an environment in which a hosted application may safely be provided with capabilities of a local device.

FIG. 3 symbolically illustrates a more specific example of an app host environment for practicing the principles described herein.

FIG. 4 symbolically illustrates a more specific environment for hosting applications and providing the hosted applications with device capabilities of a local device

FIG. 5 illustrates a flow chart of an example method for hosting one or more web applications and providing local device capabilities to the one or more web applications.

### DETAILED DESCRIPTION

At least some embodiments described herein relate to hosting one or more web applications and providing local device capabilities to the one or more web applications. For example, embodiments may include hosting one or more second applications within a first application. A call from the one or more second applications may be performed to a device abstraction layer of the first application. Such a performed call may comprise a request to access a capability of a local device. Upon receiving the call, the device abstraction layer may verify that the performed call is permitted. In response to the first application verifying that the performed call is permitted, the one or more second applications may be permitted to access the capability of the local device that was requested.

Accordingly, an app host utilizing a device abstraction layer may provide hosted applications with access to cross-platform functionality and local device capabilities, while also sandboxing hosted applications to ensure safety of local devices. Furthermore, the app host may allow for opening/closing hosted apps, allowing multiple apps to be open at any given time, defining hosted app capabilities, modifying hosted apps, building UI around and on top of hosted apps on all major mobile platforms at once, and easily updating an infrastructure of the app host.

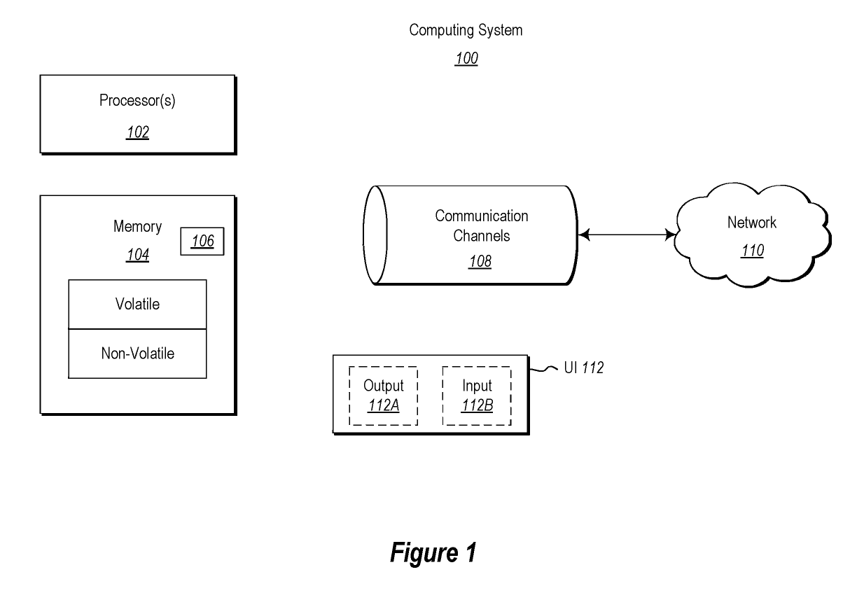

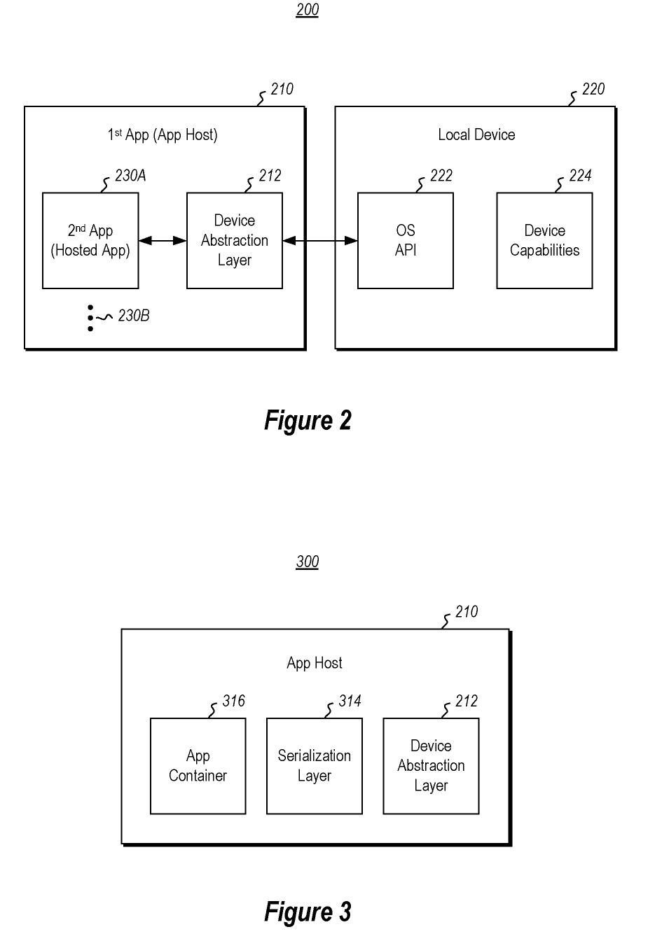

Because the principles described herein operate in the context of a computing system, a computing system will first be described with respect to FIG. 1, as an enabling technology for the principles described herein. Thereafter, further details regarding hosting one or more web applications and providing local device capabilities to the one or more web applications will be described with respect to FIGS. 2 through 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

The computing system 100 has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “controller”, “validator”, “runner”, “deployer”, “orchestrator”, “builder” or the like, may also be used. As used in this description and in the case, these terms (regardless of whether the term is modified with one or more modifiers) are also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth. In accordance with the principles describe herein, alerts (whether visual, audible and/or tactile) may be presented via the output mechanism 112A.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

FIG. 2 symbolically illustrates an environment 200 in which a hosted application may safely be provided with capabilities of a local device. FIG. 2 includes an app host 210, that is capable of hosting one or more applications (e.g., hosted application 230A). Hosted application 230A can be any type of software application, but more generally may comprise a web application (e.g., an HTML application). While only one hosted app 230A is illustrated, ellipses 230B represent that there may be any number of hosted apps executing within app host 210. As shown, app host 210 may include a device abstraction layer 212 that is capable of communicating with both the hosted application 230A, as well as an operating system (OS) application program interface (API) 222 of a local device 220, as described more fully herein.

Local device 220 may comprise any type of computer device. For example, local device 220 may comprise a smart phone, tablet, desktop computer, laptop computer, smart watch, or any other applicable computer-related device. Furthermore, local device 220 may use any applicable operating system, including as examples only, MICROSOFT WINDOWS®, APPLE OS X®, APPLE IOS®, GOOGLE ANDROID™, GOOGLE CHROME OS™, LINUX®, UBUNTU®, and so forth. Accordingly, the OS API 222 may be able to communicate with outside resources attempting to communicate with the local device, as well as device capabilities 224 of the local device. Local device capabilities 224 may include any applicable services, inputs, graphics, and sensors (e.g., accessing the file system, camera, gps, accelerometer, gyroscope).

In its most simple form, the environment illustrated in FIG. 2 may allow the hosted app 230A to communicate with device abstraction layer 212 of the app host when the hosted app desires to use a capability of local device 220. In response, the device abstraction layer may analyze the communication received from the hosted app in order to determine whether a desired operation associated with the communication is permitted. Assuming the desired operation is permitted, the device abstraction layer may then translate the communication received from the hosted app into a form that is understood by the OS API 222 of the local device 220. Once the local device has received the translated communication via the local device's OS API, the app host's desired operation/local device capability may be granted.

FIG. 3 symbolically illustrates a more specific example of an app host environment 300, and includes description that frequently references FIG. 2. FIG. 3 may further be representative of the app host 210 when the app host is not hosting an application. Accordingly, the components of the app host may include the device abstraction layer 212, a serialization layer 314, and an app container 316.

As briefly described, the device abstraction layer may be capable of communicating with both the hosted application 230A, as well as OS API 222 of a local device. The device abstraction layer may comprise a communication layer plugin (e.g., an APACHE CORDOVA™ (“CORDOVA”) API/Plugin) within the app host that can receive calls (from a hosted app) associated with utilizing local device capabilities and then translate those calls into OS-specific calls that are understood by the OS API 222 (included within local device 220). Accordingly, the device abstraction layer may provide an interface to a hosted app, thus allowing the hosted app to make function calls regarding local device capabilities without having to know device/OS-specific function calls. As such, any given hosted app may know how to perform calls into the device abstraction layer regarding particular devices/OS's, as well as particular capabilities of those devices/OS's (e.g., accessing a service or file system, accessing sensors, and so forth). Accordingly, the device abstraction layer provides cross-platform functionality to any hosted app, allowing a hosted app to communicate with, and use the device capabilities of, any OS/device supported by the device abstraction layer.

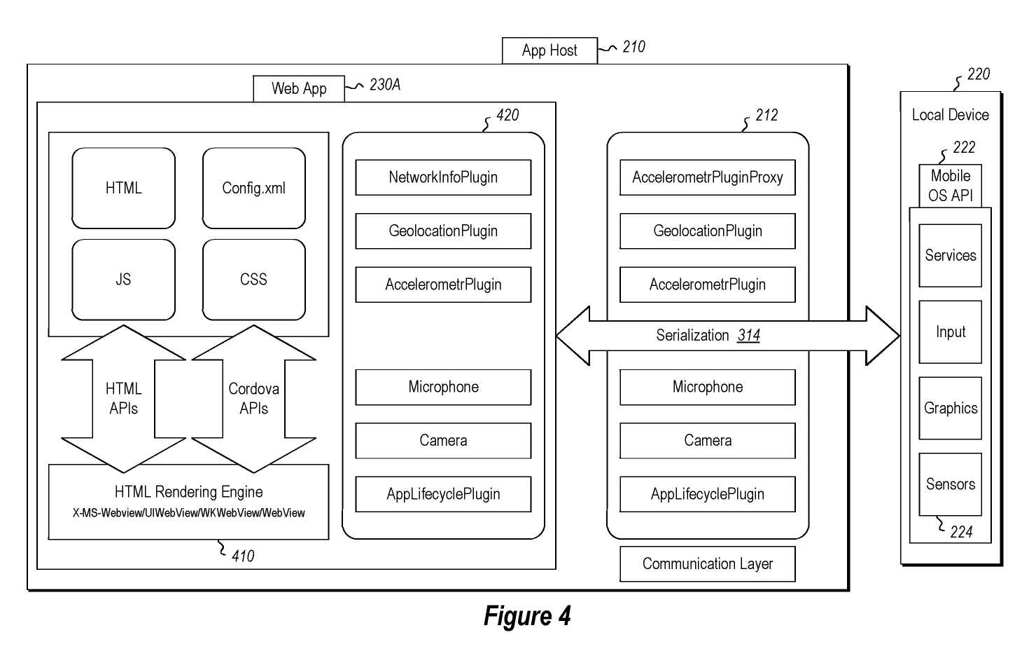

As shown in FIG. 4 below, the device abstraction layer of the app host may also perform a sandboxing function with respect to any given hosted app to ensure the legitimacy of any operation performed by a hosted application. Because a hosted app can only communicate with a given local device through the device abstraction layer, the device abstraction layer may be able to guarantee that only legitimate operations are then communicated to the OS API. As such, the device abstraction layer may have restrictions in place regarding what types of functions/operations any given hosted app may perform with respect to a local device.

For example, assume that a hosted application has performed a function call that includes a file system request with respect to a local device. In response, the device abstraction layer may validate the file system request to ensure that the hosted application is not performing a restricted function (e.g., attempting to gather restricted personal information relating to the owner of the local device), and if so, the device abstraction layer may deny the requested function. Accordingly, the device abstraction layer may analyze each function call performed by the hosted application to ensure that each function call is legitimate/valid.

As shown, the app host 210 may also include an app container. The app container in conjunction with the app host may be able to treat hosted applications comprising HTML applications as an HTML element within the context of the container/app host. Treating a hosted application as an HTML element may then allow the app host to act similar to a small app store (or even a small operating system), allowing hosted apps to be opened/closed, allowing multiple hosted apps to be open at any given time, modifying hosted apps, opening/closing hosted apps, keeping hosted apps as contained as possible within the app host, defining hosted app capabilities, and so forth. As such, when one or more apps are being hosted by the app host, each hosted app may also be sandboxed from the other apps to ensure the legitimacy of each app and each app's associated functionality. Furthermore, treating hosted apps as HTML elements may allow for building UI around and on top of hosted apps on almost any mobile platform because the UI can be implemented using a single markup/programming language. Similarly, updates (improvements/limitations) to an app host infrastructure/environment need only be done once rather than for each specific platform.

App host 210 may also include a serialization layer 314 that may allow any applicable objects to be serialized (i.e., transformed into bytes and transmitted) and deserialized (i.e. transforming a series of bytes into an object/data structure), as necessary.

FIG. 4 illustrates a more specific environment for hosting applications and providing the hosted applications with device capabilities of a local device. As shown, FIG. 4 includes hosted application 230A (i.e., the “web app”) that comprises various code (i.e., HTML, JAVASCRIPT®, and so forth) to be rendered, an HTML rendering engine 410, and an application layer 420 (e.g., a CORDOVA API/Plugin).

The application layer 420 may be responsible for, and capable of, performing all of the function calls from the hosted app to the device abstraction layer regarding specific devices/OS's and underlying device/OS capabilities, as described herein. The application layer may further provide that each such function call for a specific native capability on a specific device/OS may have a unique signature that the device abstraction layer may be able to identify as being associated with the given native capability and device/OS.

In some embodiments, a special handler may be used for each given native capability. The handler may be used to both execute the native capability request from the hosted app, as well as to send a result (i.e., confirmation or denial) back to the hosted app after the native request has been executed. Thus, a hosted application may receive feedback regarding each function call performed by the hosted application as to whether the function call was successful/unsuccessful.

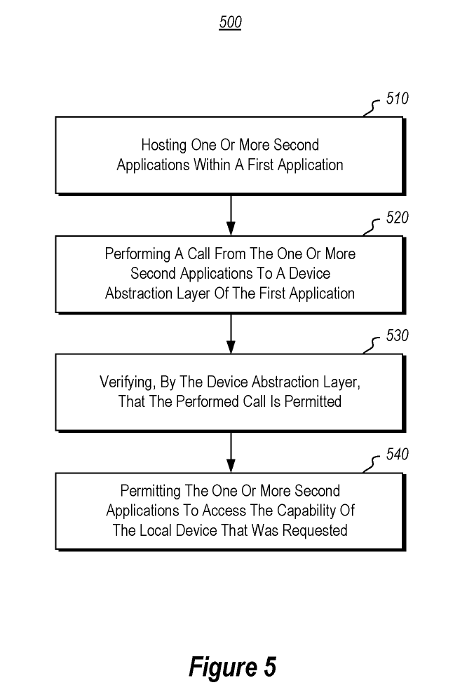

FIG. 5 illustrates a flowchart of a method 500 for hosting one or more web applications and providing local device capabilities to the one or more web applications. The method includes hosting one or more second applications within a first application (Act 510). For example, at least one of the second applications (i.e., hosted applications) may comprise an HTML application. The method 500 further includes performing a call from the one or more second applications to a device abstraction layer of the first application (Act 520), wherein the performed call comprises a request to access a capability of a local device. As described herein, the application layer 420 of the hosted app 230A may perform these calls (e.g., JAVASCRIPT calls) to the device abstraction layer 212 whenever the hosted app desires to use local device capabilities 224.

The method 500 also includes the device abstraction layer verifying that the performed call is permitted (Act 530). Accordingly, in response to receiving a call from one or more hosted applications, the device abstraction layer 212 may then be able to analyze a given request to use local device capabilities in order to ensure the request is legitimate. Once the host application 210/device abstraction layer 212 have verified that a call is permitted/legitimate, the one or more second applications may be permitted to access the capability of the local device that was requested (Act 540)

As such, if determined to be legitimate, the device abstraction layer 212 may notify the app host 210 that the request was legitimate/successful. The device abstraction layer 212 may then translate the function call of the hosted application 230A to any given platform-specific code and subsequently use the platform-specific code to call into the OS API 222 of the particular device 220. In response, the OS API 222 may be able to call into the given device capability 224 to thereby provide the requested local device capability to the hosted app.

In a more specific example, suppose an end user is accessing a hosted application using a mobile phone running an ANDROID OS. If the end user attempts to use the mobile phone's camera via the hosted HTML application, the application layer of the hosted application may perform a JAVASCRIPT call to the device abstraction layer requesting access to the mobile phone's camera. The device abstraction layer may then analyze the camera request to use the mobile phone's camera in order to ensure the camera request's legitimacy. Assuming the camera request is legitimate, the device abstraction layer may then notify the app host (and further the hosted app) that the camera request was legitimate/successful. The device abstraction layer may then translate the JAVASCRIPT function call into ANDROID-specific code and perform a call to the OS API of the mobile phone. At this point, the OS API may call into the camera to thereby provide camera access to the hosted application. As such, the end user may then be able to gain access to the camera for the purpose requested (e.g., to take a picture, to access a photo library associated with the camera, to record video, and so forth).

In another example, suppose a hosted application is being accessed by an end user of a mobile device running IOS. The hosted application may include a user interface that allows an end user to access various local capabilities. For instance, the user interface may include controls that allow an end user to access a file(s) of the mobile device's file system, a camera of the mobile device, an accelerometer of the mobile device, and gps coordinates of the mobile device. Further suppose that the end user attempts to gain access to a particular file stored within the file system of the mobile device by selecting the user interface control that allows access to locally stored files (i.e., files stored within the mobile device's file system). In response to the user's request, the application layer of the hosted application may perform a JAVASCRIPT call to the device abstraction layer requesting access to the particular file stored on the mobile device's file system. The device abstraction layer may then analyze the file request in order to ensure the camera request's legitimacy.

In cases where the file request is not legitimate, the device abstraction layer may deny the request and inform both the app host and the hosted app of such. For instance, if a malicious request has been performed to gain access to restricted files (e.g., files having personal information) or restricted portions of the file system, the device abstraction layer may deny such requests. However, in cases where the file request is legitimate, the device abstraction layer may then notify both the app host and the hosted app that the file request was successful. The device abstraction layer may then translate the JAVASCRIPT function call into IOS-specific code and perform a call to the OS API of the mobile phone. The OS API may then call into the file system to thereby provide the end user of the hosted application with access to the requested file(s). As such, the end user may then be able to use the file(s) for the purpose requested (e.g., to modify the file, to use the file as input/output, to view the file, and so forth)

In this way, an app host utilizing a device abstraction layer may provide hosted applications with access to cross-platform functionality and local device capabilities, while also sandboxing hosted applications to ensure safety of local devices. Furthermore, the app host may allow for opening/closing hosted apps, allowing multiple apps to be open at any given time, defining hosted app capabilities, modifying hosted apps, building UI around and on top of hosted apps on all major mobile platforms at once, and easily updating an infrastructure of the app host.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more processors; and
one or more computer readable storage media having stored thereon computer-executable instructions that are executable by the one or more processors to cause the computer system to host one or more web applications and provide local device capabilities to the one or more web applications, the computer-executable instructions including instructions that are executable to cause the computer system to perform at least the following:
host one or more second applications within a first application;
perform a call from the one or more hosted second applications to a device abstraction layer of the first application to thereby access a capability of a local device;
verify, by the device abstraction layer, that the performed call is permitted; and
in response to the first application verifying that the performed call is permitted, permit the one or more second applications to access the capability of the local device.

2. The computer system of claim 1, wherein at least one of the one or more second applications comprises a web application.

3. The computer system of claim 2, wherein the web application comprises an HTML application.

4. The computer system of claim 1, wherein the device abstraction layer comprises a communication layer plugin.

5. The computer system of claim 4, wherein the communication layer plugin comprises a Cordova plugin.

6. The computer system of claim 1, wherein the capability of the local device comprises a camera of the local device.

7. The computer system of claim 1, wherein the device abstraction layer receives calls associated with utilizing a local device capability from the one or more second applications and translates the received calls into calls understood by an application programming interface of an operating system of the local device.

8. The computer system of claim 1, wherein the one or more second applications include an application layer that performs calls to the device abstraction layer.

9. The computer system of claim 8, wherein each call performed by the application layer includes a unique signature associated with both a particular capability and a particular operating system of the local device.

10. The computer system of claim 8, wherein the application layer comprises a Cordova plugin.

11. A method, implemented at a computer system that includes one or more processors, for hosting one or more web applications and providing local device capabilities to the one or more web applications, the method comprising:
hosting one or more second applications within a first application;
performing a call from the one or more second applications to a device abstraction layer of the first application, the performed call comprising a request to access a capability of a local device;
verifying, by the device abstraction layer, that the performed call is permitted; and
in response to the first application verifying that the performed call is permitted, permitting the one or more second applications to access the capability of the local device that was requested.

12. The computer system of claim 11, wherein the device abstraction layer comprises a communication layer plugin.

13. The computer system of claim 12, wherein the communication layer plugin comprises a Cordova plugin.

14. The method of claim 11, further comprising translating, by the device abstraction layer, the performed call into a form that is understood by an application program interface of an operating system of the local device, when the performed call is permitted.

15. The method of claim 11, further comprising denying the one or more hosted applications access to the capability of the local device that was requested, when the performed call is not permitted.

16. The method of claim 11, wherein a handler is used to both execute the performed call from the one or more second applications and return a result of the call to the one or more second applications.

17. The method of claim 11, wherein the one or more second applications include an application layer that performs calls to the device abstraction layer.

18. The method of claim 17, wherein each call performed by the application layer includes a unique signature associated with both a particular capability and a particular operating system of the local device.

19. A method, implemented at a computer system that includes one or more processors, for hosting one or more web applications and providing local device capabilities to the one or more web applications, the method comprising:
hosting one or more applications;
receiving a call from the one or more applications at a device abstraction layer, the call comprising a request to access a capability of a local device;
verifying that the request to access a capability of the local device is permitted; and
permitting the one or more second applications to access the capability of the local device when the request is permitted.

20. The method of claim 19, further comprising translating, by the device abstraction layer, the performed call into a form that is understood by an application program interface of an operating system of the local device, when the performed call is permitted.
